(19) United States
(12) Patent Application Publication
(10) Pub. No.: US 2025/0184695 A1
(43) Pub. Date: Jun. 5, 2025

(54) TECHNIQUES FOR OBTAINING NETWORK SERVICE INFORMATION

(71) Applicant: QUALCOMM Incorporated, San Diego, CA (US)

(72) Inventors: Sebastian SPEICHER, Wallisellen (CH); Haris ZISIMOPOULOS, London (GB); Lenaig Genevieve CHAPONNIERE, La Jolla, CA (US); Miguel GRIOT, La Jolla, CA (US); Stefano FACCIN, San Ysidro, CA (US); Hong CHENG, Basking Ridge, NJ (US); Amer CATOVIC, San Diego, CA (US)

(21) Appl. No.: 18/836,966

(22) PCT Filed: Mar. 21, 2023
(86) PCT No.: PCT/US2023/015776

§ 371 Date: Aug. 8, 2024

(30) Foreign Application Priority Data
May 6, 2022 (GR) 20220100375

(51) Int. Cl. H04W 4/06; G06F 16/955; H04L 67/51

(52) U.S. Cl. CPC H04W 4/06; G06F 16/955; H04L 67/51

(57) ABSTRACT

Various aspects of the present disclosure generally relate to wireless communication. In some aspects, a user equipment (UE) may receive broadcast information associated with one or more services provided by a network. The UE may obtain a location for accessing service information that describes the one or more services based at least in part on the broadcast information. The CE may access the service information based at least in part on the location. Numerous other aspects are described.

### CROSS-REFERENCE TO RELATED APPLICATION

This Patent application claims priority to Greece Patent Application Serial No. 20220100375, filed on May 6, 2022, entitled “TECHNIQUES FOR OBTAINING NETWORK SERVICE INFORMATION,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for obtaining network service information.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving broadcast information associated with one or more services provided by a network. The method may include obtaining a location for accessing service information that describes the one or more services based at least in part on the broadcast information. The method may include accessing the service information based at least in part on the location.

Some aspects described herein relate to a method of wireless communication performed by a UE. The method may include obtaining an indication of one or more detected networks based at least in part on a scanning operation. The method may include receiving, from a network entity, an indication of one or more available networks. The method may include selecting a network based at least in part on the network being included in the indication of the one or more detected networks and the indication of the one or more available networks.

Some aspects described herein relate to a method of wireless communication performed by a network entity. The method may include obtaining a configuration for transmitting broadcast information that is associated with one or more services provided by a network and that enables a UE to obtain a location for accessing service information that describes the one or more services. The method may include transmitting a broadcast communication that includes the broadcast information.

Some aspects described herein relate to an apparatus for wireless communication performed by a UE. The apparatus may include a memory and one or more processors, coupled to the memory. The one or more processors may be configured to receive broadcast information associated with one or more services provided by a network. The one or more processors may be configured to obtain a location for accessing service information that describes the one or more services based at least in part on the broadcast information. The one or more processors may be configured to access the service information based at least in part on the location.

Some aspects described herein relate to an apparatus for wireless communication performed by a UE. The apparatus may include a memory and one or more processors, coupled to the memory. The one or more processors may be configured to obtain an indication of one or more detected networks based at least in part on a scanning operation. The one or more processors may be configured to receive, from a network entity, an indication of one or more available networks. The one or more processors may be configured to select a network based at least in part on the network being included in the indication of the one or more detected networks and the indication of the one or more available networks.

Some aspects described herein relate to an apparatus for wireless communication performed by a network entity. The apparatus may include a memory and one or more processors, coupled to the memory. The one or more processors may be configured to obtain a configuration for transmitting broadcast information that is associated with one or more services provided by a network and that enables a UE to obtain a location for accessing service information that describes the one or more services. The one or more processors may be configured to transmit a broadcast communication that includes the broadcast information.

Some aspects described herein relate to a non-transitory computer-readable medium that stores a set of instructions for wireless communication by a UE. The set of instructions, when executed by one or more processors of the UE, may cause the UE to receive broadcast information associated with one or more services provided by a network. The set of instructions, when executed by one or more processors of the UE, may cause the UE to obtain a location for accessing service information that describes the one or more services based at least in part on the broadcast information. The set of instructions, when executed by one or more processors of the UE, may cause the UE to access the service information based at least in part on the location.

Some aspects described herein relate to a non-transitory computer-readable medium that stores a set of instructions for wireless communication by a UE. The set of instructions, when executed by one or more processors of the UE, may cause the UE to obtain an indication of one or more detected networks based at least in part on a scanning operation. The set of instructions, when executed by one or more processors of the UE, may cause the UE to receive, from a network entity, an indication of one or more available networks. The set of instructions, when executed by one or more processors of the UE, may cause the UE to select a network based at least in part on the network being included in the indication of the one or more detected networks and the indication of the one or more available networks.

Some aspects described herein relate to a non-transitory computer-readable medium that stores a set of instructions for wireless communication by a network entity. The set of instructions, when executed by one or more processors of the network entity, may cause the network entity to obtain a configuration for transmitting broadcast information that is associated with one or more services provided by a network and that enables a UE to obtain a location for accessing service information that describes the one or more services. The set of instructions, when executed by one or more processors of the network entity, may cause the network entity to transmit a broadcast communication that includes the broadcast information.

Some aspects described herein relate to an apparatus for wireless communication. The apparatus may include means for receiving broadcast information associated with one or more services provided by a network. The apparatus may include means for obtaining a location for accessing service information that describes the one or more services based at least in part on the broadcast information. The apparatus may include means for accessing the service information based at least in part on the location.

Some aspects described herein relate to an apparatus for wireless communication. The apparatus may include means for obtaining an indication of one or more detected networks based at least in part on a scanning operation. The apparatus may include means for receiving, from a network entity, an indication of one or more available networks. The apparatus may include means for selecting a network based at least in part on the network being included in the indication of the one or more detected networks and the indication of the one or more available networks.

Some aspects described herein relate to an apparatus for wireless communication. The apparatus may include means for obtaining a configuration for transmitting broadcast information that is associated with one or more services provided by a network and that enables a UE to obtain a location for accessing service information that describes the one or more services. The apparatus may include means for transmitting a broadcast communication that includes the broadcast information.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of a disaggregated base station architecture, in accordance with the present disclosure.

FIG. 4 is a diagram illustrating an example of broadcasting human-readable service information, in accordance with the present disclosure.

FIG. 5 is a diagram illustrating an example associated with obtaining network service information, in accordance with the present disclosure.

FIG. 6 is a diagram illustrating an example associated with network selection, in accordance with the present disclosure.

FIG. 7 is a diagram illustrating an example process associated with obtaining network service information, in accordance with the present disclosure.

FIG. 8 is a diagram illustrating an example process associated with network selection, in accordance with the present disclosure.

FIG. 9 is a diagram illustrating an example process associated with obtaining network service information, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

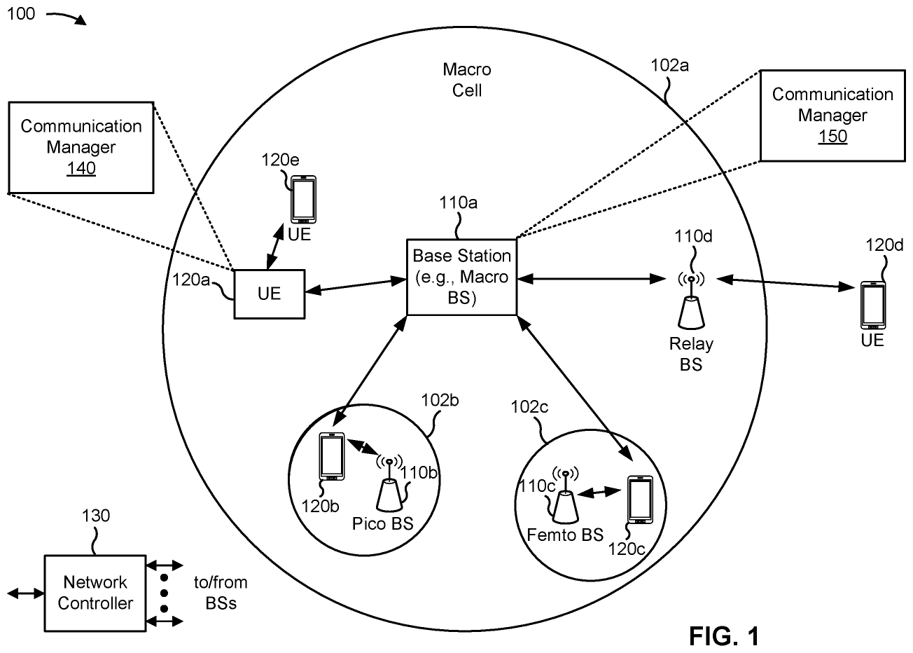

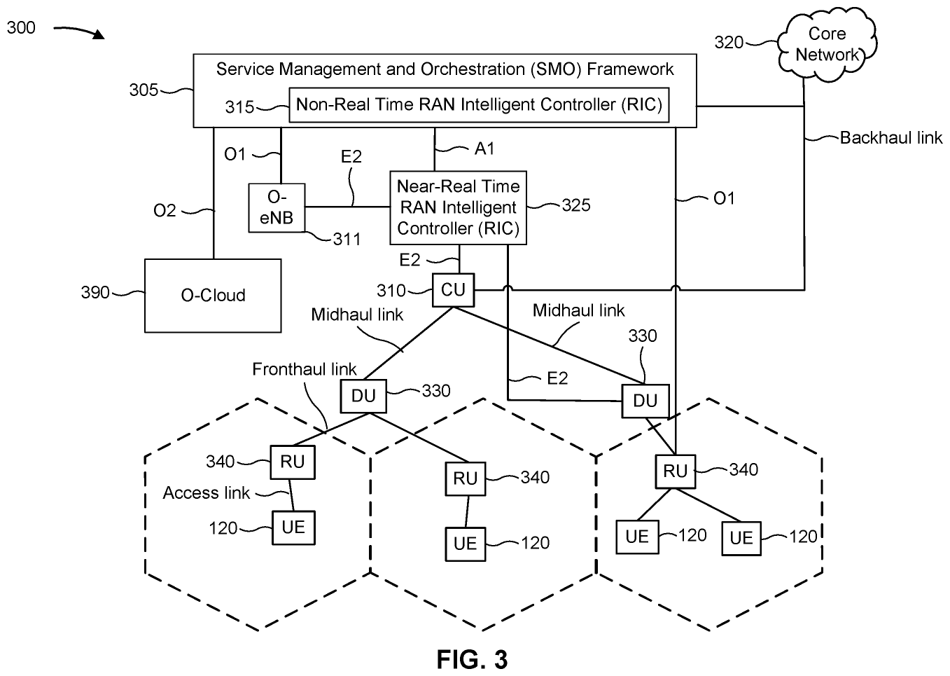

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Moreover, although depicted as an integral unit in FIG. 1, aspects of the disclosure are not so limited. In some other aspects, the functionality of the base station 110 may be disaggregated according to an open radio access network (RAN) (O-RAN) architecture or the like, which is described in more detail in connection with FIG. 3. Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases. NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHZ-7.125 GHz) and FR2 (24.25 GHz-52.6 GHz). It should be understood that although a portion of FR1 is greater than 6 GHz. FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHZ). FR4 (52.6 GHz-114.25 GHZ), and FR5 (114.25 GHZ-300 GHz). Each of these higher frequency bands falls within the EHF band.

With the above examples in mind, unless specifically stated otherwise, it should be understood that the term “sub-6 GHZ” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive broadcast information associated with one or more services provided by a network: obtain a location for accessing service information that describes the one or more services based at least in part on the broadcast information; and access the service information based at least in part on the location. Additionally, or alternatively, the communication manager 140 may perform one or more other operations described herein.

In some aspects, the communication manager 140 may obtain an indication of one or more detected networks based at least in part on a scanning operation: receive, from a network entity, an indication of one or more available networks; and select a network based at least in part on the network being included in the indication of the one or more detected networks and the indication of the one or more available networks. Additionally, or alternatively, the communication manager 140 may perform one or more other operations described herein.

In some aspects, a network entity (e.g., the base station 110) may include a communication manager 150. As described in more detail elsewhere herein, the communication manager 150 may obtain a configuration for transmitting broadcast information that is associated with one or more services provided by a network and that enables a UE to obtain a location for accessing service information that describes the one or more services; and transmit a broadcast communication that includes the broadcast information. Additionally, or alternatively, the communication manager 150 may perform one or more other operations described herein.

As indicated above, FIG. 1 is provided as an example. Other examples may differ from what is described with regard to FIG. 1.

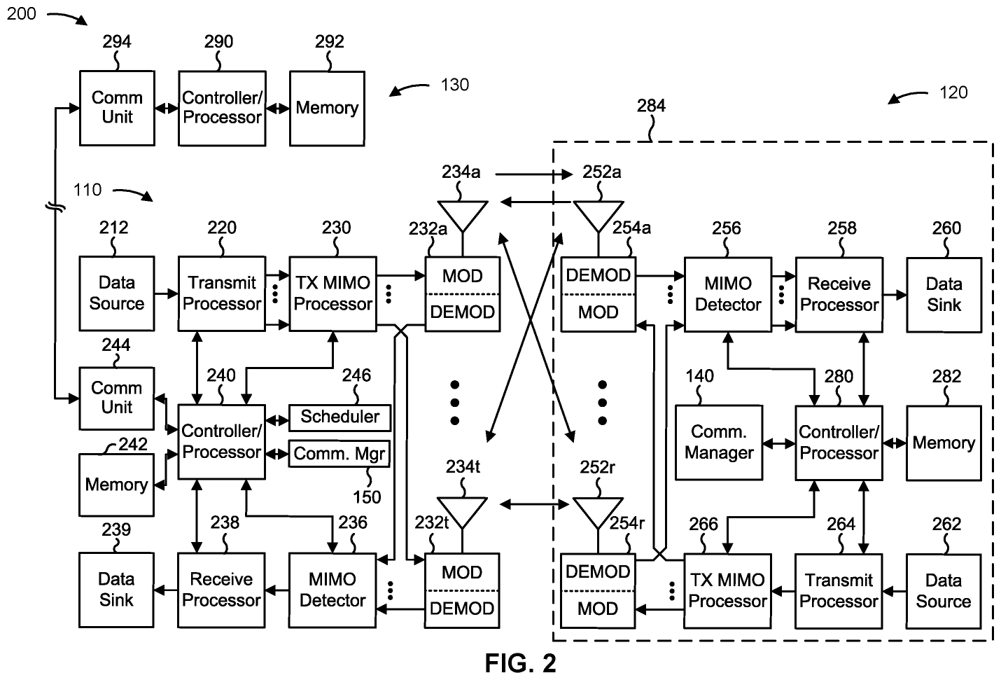

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g. T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

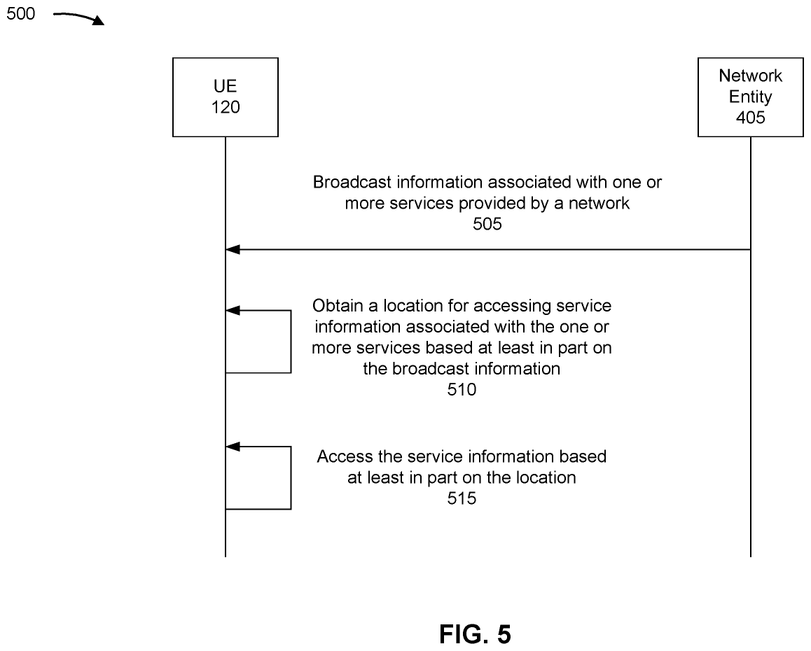

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-11).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-11).

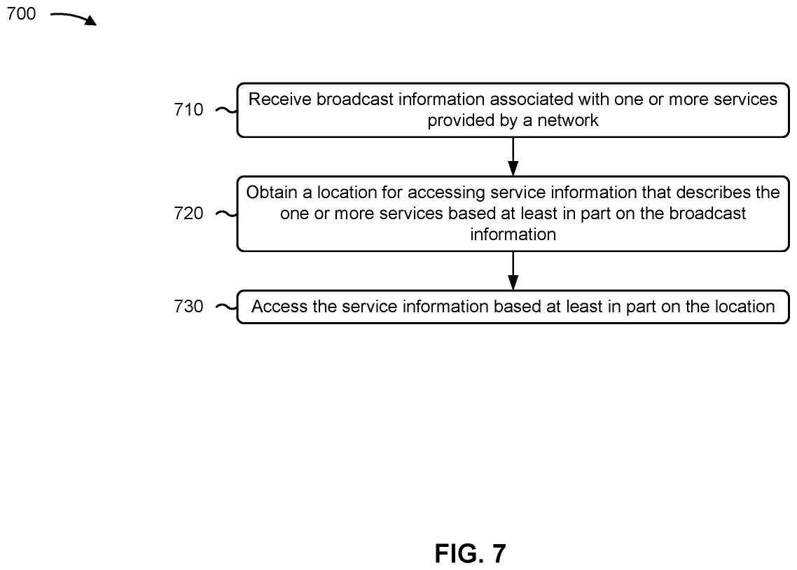

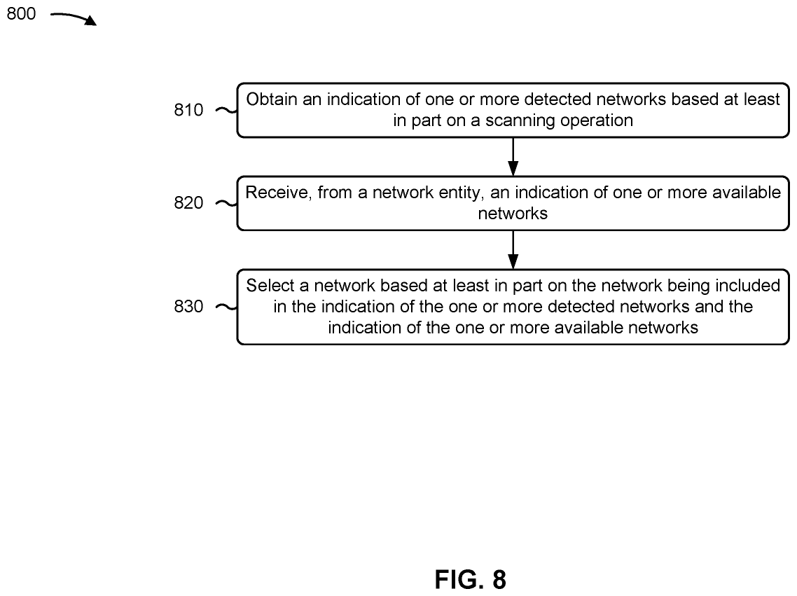

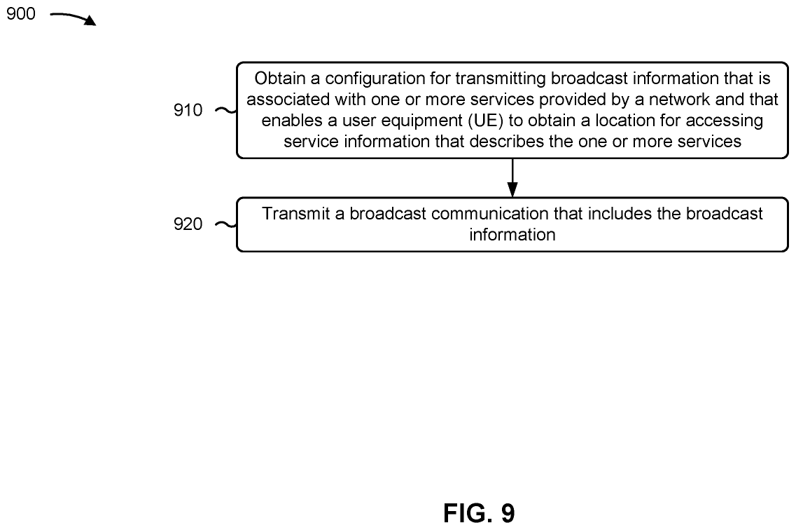

The controller/processor 240 of the base station 110, the controller/processor 280 of the UE 120, and/or any other component(s) of FIG. 2 may perform one or more techniques associated with obtaining network service information, as described in more detail elsewhere herein. For example, the controller/processor 240 of the base station 110, the controller/processor 280 of the UE 120, and/or any other component(s) of FIG. 2 may perform or direct operations of, for example, process 700 of FIG. 7, process 800 of FIG. 8, process 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE includes means for receiving broadcast information associated with one or more services provided by a network: means for obtaining a location for accessing service information that describes the one or more services based at least in part on the broadcast information; and/or means for accessing the service information based at least in part on the location. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE includes means for obtaining an indication of one or more detected networks based at least in part on a scanning operation; means for receiving, from a network entity, an indication of one or more available networks; and/or means for selecting a network based at least in part on the network being included in the indication of the one or more detected networks and the indication of the one or more available networks. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network entity includes means for obtaining a configuration for transmitting broadcast information that is associated with one or more services provided by a network and that enables a UE to obtain a location for accessing service information that describes the one or more services; and/or means for transmitting a broadcast communication that includes the broadcast information. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above. FIG. 2 is provided as an example. Other examples may differ from what is described with regard to FIG. 2.

FIG. 3 is a diagram illustrating an example 300 disaggregated base station architecture, in accordance with the present disclosure.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station (BS, e.g., base station 110), or one or more units (or one or more components) performing base station functionality, may be implemented in an aggregated or disaggregated architecture. For example, a BS (such as a Node B (NB), eNB, NR BS, 5G NB, access point (AP), a TRP, a cell, or the like) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual centralized unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an O-RAN (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station architecture shown in FIG. 3 may include one or more CUs 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340), as well as the Near-RT RICs 325, the Non-RT RICs 315, and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low-PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310. DUs 330. RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the non-RT RIC 315 or the Near-RT RIC 325 may be configured to tune RAN behavior or performance. For example, the non-RT RIC 315 may monitor long-term trends and patterns for performance and employ AI/ML models to perform corrective actions through the SMO Framework 305 (such as reconfiguration via 01) or via creation of RAN management policies (such as A1 policies).

As indicated above. FIG. 3 is provided as an example. Other examples may differ from what is described with regard to FIG. 3.

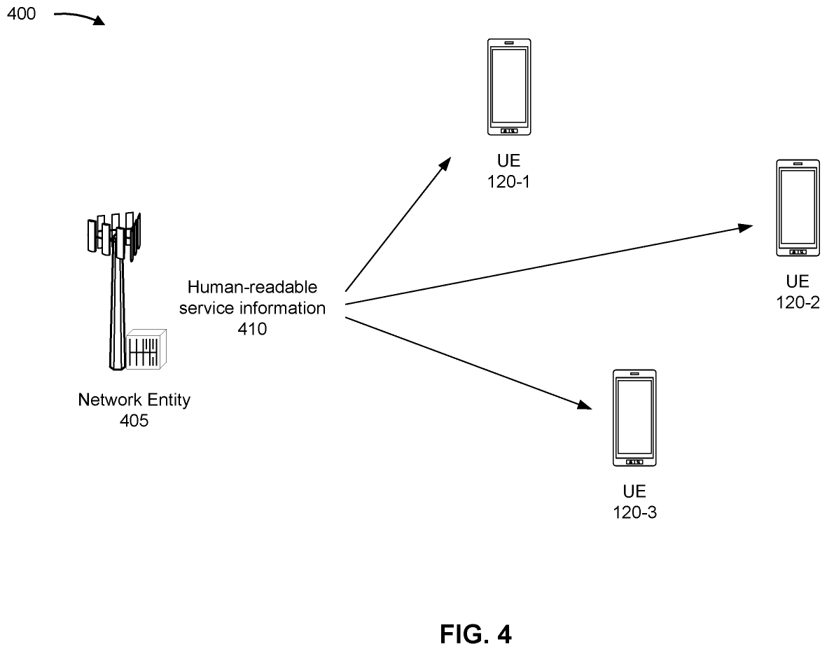

FIG. 4 is a diagram illustrating an example 400 of broadcasting human-readable service information, in accordance with the present disclosure. A network entity 405 may communicate with the UE 120 or a plurality of UEs 120. For example, the network entity 405 may communicate with the UE 120-1, UE 120-2, and UE 120-3 via broadcast communications. The network entity 405 may include some or all of the features of the base station 110, the CU 310, the DU 330, and/or the RU 340.

The network entity 405 may communicate with the UEs 120 via a public network and/or a non-public network. In some cases, a public network may be a network that can be accessed by any device that is within a coverage area of the public network and that is subscribed to a mobile network operator (MNO) associated with the public network. In contrast, a non-public network, which may also be referred to as a private network, may be a network that is associated with a single enterprise, organization, or location. In one example, the non-public network may be associated with a stadium for hosting sporting events. Only devices that are located within the stadium and have access to information provided by the stadium (e.g., information located on a ticket for entry into the stadium) may be able to access the non-public network. In another example, the non-public network may be associated with a college campus, and only devices that are registered to students, faculty, or other individuals associated with the college, and that are currently located on the college campus, may be able to access the non-public network.

In some cases, the UE 120 may not be configured with service information that describes the service or services offered by a network (e.g., a non-public network). In some cases, the network entity 405 may broadcast information such as the service information that describes the one or more services that are offered by the network. For example, the network entity 405 may broadcast the service information to the UE 120-1. UE 120-2, and UE 120-3 using a different network such as a public network. In the example that the network (e.g., the non-public network) is located in a stadium for hosting sporting events, the service information may include information that enables the UE 120 to access video information associated with the sporting event, such as a replay or alternate camera angle. In some cases, the service information may be human-readable service information 410. For example, the human-readable service information 410 may be a text message that informs the UE 120 (or a user of the UE 120) that the video information is available and/or that provides instructions for accessing the video information. However, broadcasting the human-readable service information 410 may require a large number of network resources and may increase the complexity for accessing the network services.

Techniques and apparatuses are described herein for obtaining network service information. In some aspects, the network entity 405 may transmit, and the UE 120 may receive, broadcast information associated with one or more services provided by a network. The UE 120 may obtain a location for accessing service information that describes the one or more services based at least in part on the broadcast information, and the UE 120 may access the service information based at least in part on the location. In some aspects, the UE 120 may obtain an indication of one or more detected networks based at least in part on a scanning operation, and the UE 120 may receive an indication of one or more networks from a network entity. The UE 120 may select a network based at least in part on the network being included in the indication of the one or more detected non-public networks and the indication of the one or more available non-public networks.

As described above, the network entity 405 may broadcast service information that describes one or more services that are provided by the network (e.g., the non-public network). In some cases, the service information may be human-readable service information. However, broadcasting the human-readable service information may require a large number of network resources and may increase the complexity for accessing the network services. Using the techniques and apparatuses described herein, the network entity 405 may transmit information that enables the UE 120 to obtain (e.g., generate) a location for accessing the service information, and the UE 120 may access the service information via the location. This may reduce the number of network resources that are needed for accessing the network services and may decrease the complexity for accessing the network services.

As indicated above, FIG. 4 is provided as an example. Other examples may differ from what is described with regard to FIG. 4.

FIG. 5 is a diagram illustrating an example 500 of obtaining network service information, in accordance with the present disclosure. The UE 120 may communicate with the network entity 405.

As shown in connection with reference number 505, the network entity 405 may transmit, and the UE 120 may receive, broadcast information associated with one or more services provided by a network. For example, the network entity 405 may broadcast service information that describes one or more services that are provided by a non-public network. In some aspects, the network entity 405 may have an existing connection to the UE 120 via a different network, such as a public network. The UE 120 may receive the service information, from the network entity 405 and via the different network (e.g., the public network), that describes the one or more services that are offered by the network (e.g., the non-public network).

In some aspects, the UE 120 may be located within an area that is associated with the network (e.g., the non-public network). For example, the UE 120 may be located in a stadium that is hosting a sporting event. The stadium that is hosting the sporting event may offer a non-public network that can be used by one or more devices. In some aspects, the network entity 405 may transmit service information that describes one or more services that are offered by the network associated with the stadium. For example, the service information may include information that enables the UE 120 to access and/or display video information associated with the sporting event, such as a replay or alternate camera angle associated with the sporting event.

As shown in connection with reference number 510, the UE 120 may obtain a location for accessing service information that describes the one or more services. The UE 120 may obtain the location based at least in part on the broadcast information. For example, the UE 120 may generate the location for accessing the service information based at least in part on the broadcast information. In some aspects, the location may be a uniform resource locator (URL) that points to a website that provides the service information that describes the one or more services. In some aspects, the location may be a broadcast or multicast transmission that provides the service information that describes the one or more services. Additional details regarding these features are described in the examples below.

In a first example, the broadcast information may include a key. For example, the broadcast information may include a key that is based at least in part on a number and/or a text string. The UE 120 may generate a URL based at least in part on the key. For example, the UE 120 may generate the URL by embedding the key into a webpage address. In some aspects, the UE 120 may generate the URL by embedding the key into the webpage as follows: https://<key>.npn-service-information.com. In some aspects, the UE 120 may generate the URL based at least in part on the key and a tracking area code (TAC) associated with the network. For example, the UE 120 may generate the URL as follows: https://<key>.<TAC>.npn-service-information.com.

In a second example, the broadcast information may include a flag or an indication of a flag. For example, the broadcast information may include a “localized services” flag or an indication of a state of the flag (e.g., “on” or “off”). The UE 120 may generate a URL based at least in part on the flag. For example, the UE 120 may generate the URL as follows: https://<TAC>.<NID><MNC><MCC>.npn-service-information.com. In some aspects, the network ID (NID) may only be included in the URL if that the network is a standalone non-public network (SNPN).

In a third example, the broadcast information may include a temporary mobile group identity (TMGI). The TMGI may point to a broadcast or multicast service that provides the service information describing the one or more services that are offered by the network. For example, the UE 120 may receive the TMGI via the public network and may access the broadcast or multicast service that provides the service information for the one or more services provided by non-public network without registering (e.g., subscribing to) the non-public network.

In a fourth example, the broadcast information may include the URL. For example, the broadcast information may include a URL that links to a website that contains the service information describing the one or more services that are offered by the network.

The above examples are provided for examples only. The network entity 405 may broadcast, and the UE 120 may receive, any type of information that enables the UE 120 to access the service information. Additionally, or alternatively, the network entity 405 may broadcast a combination of the different types of information that enable the UE 120 to access the service information.

As shown in connection with reference number 515, the UE 120 may access the service information based at least in part on the location. As described in the first example above, the UE 120 may generate a URL based at least in part on a key. As described in the second example above, the UE 120 may generate a URL based at least in part on a flag. As described in the fourth example above, the UE 120 may receive the URL directly via the broadcast information. In these examples, the UE 120 (or a user of the UE 120) may access the service information based at least in part on the URL. For example, selection of the URL (e.g., automatic selection by the UE 120 or manual selection by a user of the UE 120) may cause the UE 120 to display the service information. As described in the third example above, the UE 120 may receive a TMGI that points to a broadcast or multicast service that provides the service information. In this example, the UE 120 may receive the service information without connecting to the non-public network, or prior to connecting to the non-public network.

In some aspects, the service information may describe one or more services that are provided by the network, such as the non-public network. In the example that the network is associated with the stadium that is hosting the sporting event, the service information may describe one or more video services associated with the sporting event. For example, the service information may display one or more links to a replay option, a first alternate camera angle option, and/or a second alternate camera option. Selection of the link associated with the replay option may cause the UE 120 to receive a broadcast or multicast or unicast transmission of the replay by the network and to display the replay via the display associated with the UE 120. Selection of the link associated with the first alternate camera angle or the link associated with the second alternate camera angle option may cause the UE 120 to receive a broadcast, multicast or unicast transmission by the non-public network and to display the first alternate camera angle or the second alternate camera angle, respectively, via the display associated with the UE 120. In the example that the non-public network is associated with a college campus, the service information may display one or more services offered by the college. For example, the service information may display one or more links to a map of the college campus or to dining services that are offered by the college. Selection of the link associated with the map may cause the UE 120 to display a map of the college campus. Selection of the link associated with the dining services may cause the UE 120 to display dining services that are offered by the college.

In some aspects, the UE 120 may display the service information (e.g., the one or more links) and may wait for a selection of the service information by a user of the UE 120. The UE 120 may display the network services via the display associated with the UE 120 based at least in part on the selection by the user. In some aspects, the UE 120 may automatically select one or more of the network services to be displayed by the display associated with the UE 120. For example, a configuration of the UE 120 may cause the UE 120 to automatically display a network service (e.g., a replay) based at least in part on receiving the service information.

In some aspects, the UE 120 may connect to the network (e.g., the non-public network) based at least in part on receiving the broadcast information. For example, the UE 120 may connect to the network after receiving the broadcast information and prior to generating the URL. In another example, the UE 120 may connect to the network after receiving the broadcast information and prior to accessing the TMGI pointing to the broadcast or multicast service. In another example, the UE 120 may connect to the network after generating the URL (or after receiving the URL) and prior to selecting a service associated with the network. In another example, the UE 120 may connect to the network after accessing the TMGI and prior to selecting a service associated with the network. In some aspects, the UE 120 may connect to the network after selecting the service or services that are offered by the network. For example, the UE 120 may receive the broadcast information, obtain the location (e.g., generate the URL) for accessing the network service, and select the network service to be accessed. Based at least in part on selecting the network service to be accessed, the UE 120 may connect to the network to access and/or display the network service.

As described above, the network entity 405 may broadcast service information that describes one or more services that are provided by the network (e.g., the non-public network). In some cases, the service information may be human-readable service information. However, broadcasting the human-readable service information may require a large number of network resources and may increase the complexity for accessing the network services. Using the techniques and apparatuses described herein, the network entity 405 may transmit information that enables the UE 120 to obtain a location for accessing the service information, and the UE 120 may access the service information via the location. This may reduce the number of network resources that are needed for accessing the network services and may decrease the complexity for accessing the network services.

As indicated above, FIG. 5 is provided as an example. Other examples may differ from what is described with regard to FIG. 5.

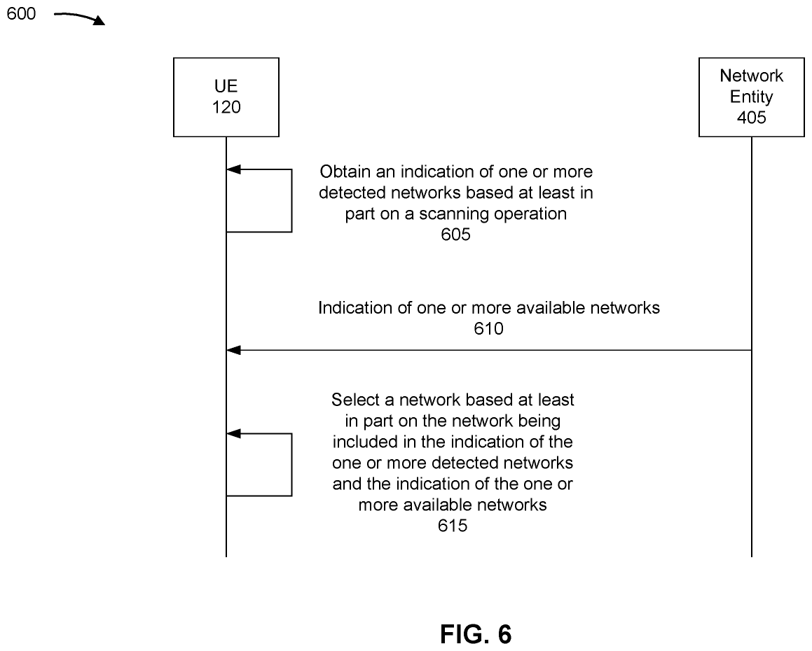

FIG. 6 is a diagram illustrating an example 600 of network selection, in accordance with the present disclosure. As described herein, the UE 120 may communicate with the network entity 405.

As shown in connection with reference number 605, the UE 120 may obtain an indication of one or more detected networks. The UE 120 may obtain the indication of the one or more detected networks based at least in part on a scanning operation. The one or more detected networks may be one or more detected non-public networks or may include one or more detected non-public networks. In some aspects, the UE 120 may scan (e.g., perform the scanning operation) for the one or more networks. For example, the UE 120 may send a packet or a ping to a plurality of networks and may determine a status of a network based at least in part on a response from the network. In some cases, the response may indicate that the network is active. A network that is indicated as active may be included in the one or more detected networks. Alternatively, a network that is indicated as inactive, or for which a response is not received, may not be included in the one or more detected networks.

As shown in connection with reference number 610, the network entity 405 may transmit, and the UE 120 may receive, an indication of one or more available networks. The one or more available networks may be one or more available non-public networks or may include one or more available non-public networks. In some aspects, the network entity 405 may be associated with a public network. However, the network entity 405 may be configured with information that indicates one or more non-public networks that are available to the UE 120. For example, the network entity 405 may be configured with information that indicates one or more networks that have a coverage area that includes the location of the UE 120. The network entity 405 may transmit an indication of the one or more available networks to the UE 120.

As shown in connection with reference number 615, the UE 120 may select a network (e.g., a non-public network) based at least in part on the network being included in the indication of the one or more detected networks and the indication of the one or more available networks. For example, the indication of the one or more detected networks may indicate network1, network2, and network3. The indication of the one or more available networks may indicate network2, network3, network4, and network5. The UE 120 may determine that both network2 and network3 are included in the indication of the one or more detected networks and the indication of the one or more available networks. Thus, the UE 120 may connect to network2 and/or network3. In some aspects, the UE 120 may connect to network2 and/or network3 for accessing services as described by the service information described above in connection with FIG. 5. For example, the UE 120 may connect to network2 and/or network3 for accessing and displaying a replay associated with a sporting event or for accessing and displaying a map associated with a college campus.

In some aspects, the UE 120 may query a serving network that is currently serving the UE 120, such as a public land mobile network (PLMN). The UE 120 may query the serving network to receive information associated with local hosting networks and services associated with the local hosting networks that are available in the current location of the UE 120. In some aspects, the UE 120 may construct a fully qualified domain name (FQDN) containing the current TAC of the PLMN serving the UE 120. The UE 120 may generate an Internet Protocol (IP) address based at least in part on the FQDN and using a domain name server (DNS). In some aspects, the UE 120 may retrieve or access the service information from the server using the IP address.

As described above, the network entity 405 may broadcast service information that describes one or more services that are provided by the network (e.g., the non-public network). In some cases, the service information may be human-readable service information. However, broadcasting the human-readable service information may require a large number of network resources and may increase the complexity for accessing the network services. Using the techniques and apparatuses described herein, the network entity 405 may transmit information that enables the UE 120 to obtain a location for accessing the service information, and the UE 120 may access the service information via the location. This may reduce the number of network resources that are needed for accessing the network services and may decrease the complexity for accessing the network services.

As indicated above, FIG. 6 is provided as an example. Other examples may differ from what is described with regard to FIG. 6.

FIG. 7 is a diagram illustrating an example process 700 performed, for example, by a UE, in accordance with the present disclosure. Example process 700 is an example where the UE (e.g., UE 120) performs operations associated with techniques for obtaining network service information.

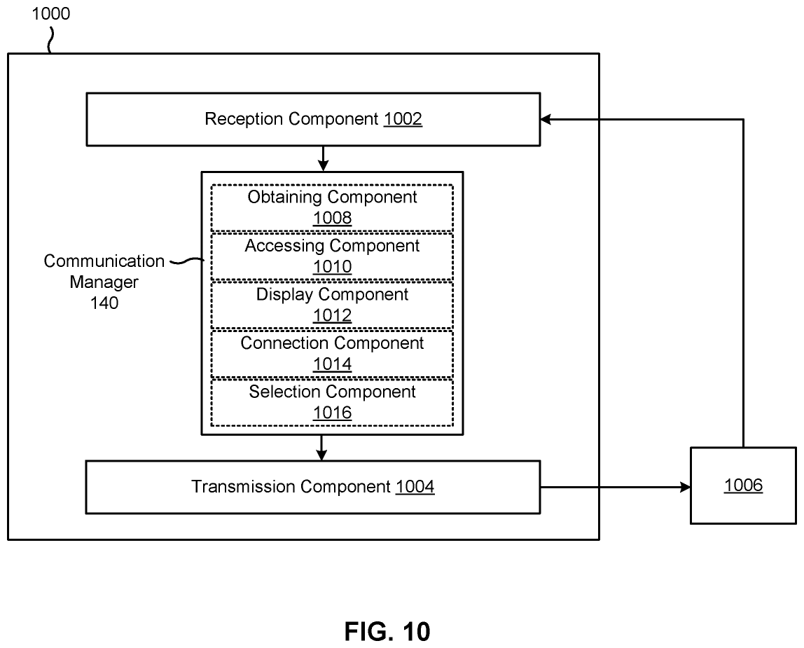

As shown in FIG. 7, in some aspects, process 700 may include receiving broadcast information associated with one or more services provided by a network (block 710). For example, the UE (e.g., using communication manager 140 and/or reception component 1002, depicted in FIG. 10) may receive broadcast information associated with one or more services provided by a network, as described above.

As further shown in FIG. 7, in some aspects, process 700 may include obtaining a location for accessing service information that describes the one or more services based at least in part on the broadcast information (block 720). For example, the UE (e.g., using communication manager 140 and/or obtaining component 1008, depicted in FIG. 10) may obtain a location for accessing service information that describes the one or more services based at least in part on the broadcast information, as described above.

As further shown in FIG. 7, in some aspects, process 700 may include accessing the service information based at least in part on the location (block 730). For example, the UE (e.g., using communication manager 140 and/or accessing component 1010, depicted in FIG. 10) may access the service information based at least in part on the location, as described above.

Process 700 may include additional aspects, such as any single aspect or any combination of aspects described below and/or in connection with one or more other processes described elsewhere herein.

In a first aspect, receiving the broadcast information comprises receiving a key, wherein obtaining the location for accessing the service information comprises generating a URL based at least in part on the key, and wherein accessing the service information comprises accessing the service information via the URL.

In a second aspect, alone or in combination with the first aspect, generating the URL based at least in part on the key comprises generating the URL based at least in part on the key and a tracking area code.

In a third aspect, alone or in combination with one or more of the first and second aspects, receiving the broadcast information comprises receiving an indication of a flag, wherein obtaining the location for accessing the service information comprises generating a URL based at least in part on the indication of the flag, and wherein accessing the service information comprises accessing the service information via the URL.

In a fourth aspect, alone or in combination with one or more of the first through third aspects, receiving the broadcast information comprises receiving a TMGI, wherein obtaining the location for accessing the service information comprises obtaining a location of a broadcast or multicast service associated with the TMGI, and wherein accessing the service information comprises accessing the service information via the broadcast or multicast service.

In a fifth aspect, alone or in combination with one or more of the first through fourth aspects, accessing the service information via the broadcast or multicast service comprises accessing the service information via the broadcast or multicast service without registering to the network or prior to registering to the network.

In a sixth aspect, alone or in combination with one or more of the first through fifth aspects, receiving the broadcast information comprises receiving a URL that is included in a broadcast message, wherein obtaining the location for accessing the service information comprises obtaining the URL from the broadcast message, and wherein accessing the service information comprises accessing the service information via the URL.

In a seventh aspect, alone or in combination with one or more of the first through sixth aspects, process 700 includes displaying the service information via a display associated with the UE.

In an eighth aspect, alone or in combination with one or more of the first through seventh aspects, process 700 includes receiving an indication of a selected service of the one or more services provided by the network, and displaying information associated with the selected service based at least in part on the indication of the selected service.

In a ninth aspect, alone or in combination with one or more of the first through eighth aspects, receiving the indication of the selected service comprises receiving an indication of a manual selection of the service by a user of the UE.

In a tenth aspect, alone or in combination with one or more of the first through ninth aspects, process 700 includes connecting to the network prior to displaying the information associated with the selected service.

In an eleventh aspect, alone or in combination with one or more of the first through tenth aspects, receiving the broadcast information comprises receiving the broadcast information via a different network.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a UE, in accordance with the present disclosure. Example process 800 is an example where the UE (e.g., UE 120) performs operations associated with techniques for obtaining network service information.

As shown in FIG. 8, in some aspects, process 800 may include obtaining an indication of one or more detected networks based at least in part on a scanning operation (block 810). For example, the UE (e.g., using communication manager 140 and/or obtaining component 1008, depicted in FIG. 10) may obtain an indication of one or more detected networks based at least in part on a scanning operation, as described above.

As further shown in FIG. 8, in some aspects, process 800 may include receiving, from a network entity, an indication of one or more available networks (block 820). For example, the UE (e.g., using communication manager 140 and/or reception component 1002, depicted in FIG. 10) may receive, from a network entity, an indication of one or more available networks, as described above.

As further shown in FIG. 8, in some aspects, process 800 may include selecting a network based at least in part on the network being included in the indication of the one or more detected networks and the indication of the one or more available networks (block 830). For example, the UE (e.g., using communication manager 140 and/or selection component 1016, depicted in FIG. 10) may select a network based at least in part on the network being included in the indication of the one or more detected networks and the indication of the one or more available networks, as described above.

Process 800 may include additional aspects, such as any single aspect or any combination of aspects described below and/or in connection with one or more other processes described elsewhere herein.

In a first aspect, process 800 includes connecting to the network based at least in part on selecting the network.

In a second aspect, alone or in combination with the first aspect, process 800 includes accessing service information associated with one or more services provided by the network.

In a third aspect, alone or in combination with one or more of the first and second aspects, receiving the indication of the one or more available networks comprises generating a FQDN that includes a current tracking area code of a serving network that is serving the UE, generating an IP address based at least in part on the FQDN and a domain name system, and receiving the indication of the one or more available networks using the IP address.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network entity, in accordance with the present disclosure. Example process 900 is an example where the network entity (e.g., network entity 405) performs operations associated with techniques for obtaining network service information.

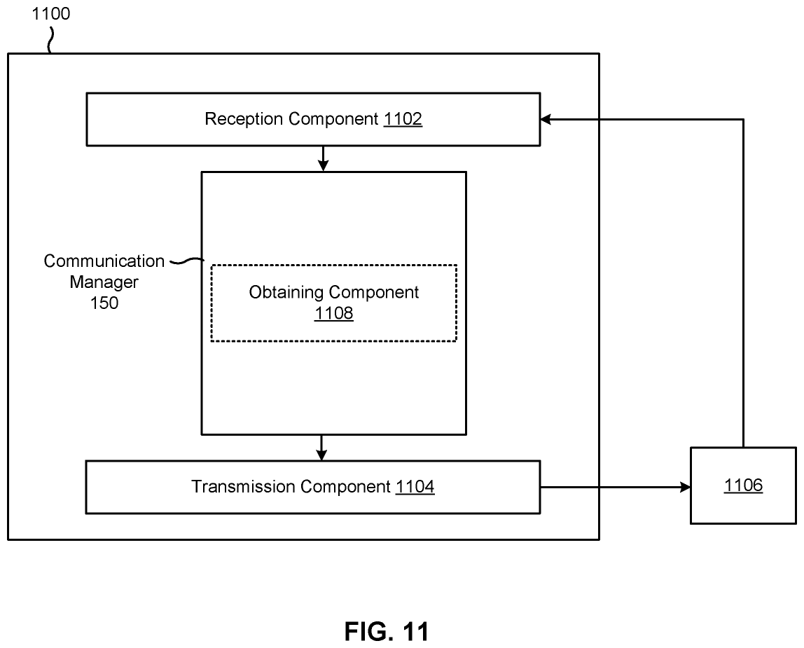

As shown in FIG. 9, in some aspects, process 900 may include obtaining a configuration for transmitting broadcast information that is associated with one or more services provided by a network and that enables a UE to obtain a location for accessing service information that describes the one or more services (block 910). For example, the network entity (e.g., using communication manager 150 and/or obtaining component 1108, depicted in FIG. 11) may obtain a configuration for transmitting broadcast information that is associated with one or more services provided by a network and that enables a UE to obtain a location for accessing service information that describes the one or more services, as described above.

As further shown in FIG. 9, in some aspects, process 900 may include transmitting a broadcast communication that includes the broadcast information (block 920). For example, the network entity (e.g., using communication manager 150 and/or transmission component 1104, depicted in FIG. 11) may transmit a broadcast communication that includes the broadcast information, as described above.

Process 900 may include additional aspects, such as any single aspect or any combination of aspects described below and/or in connection with one or more other processes described elsewhere herein.

In a first aspect, transmitting the broadcast information comprises transmitting a key that enables the UE to generate a uniform resource locator for accessing the service information.

In a second aspect, alone or in combination with the first aspect, transmitting the broadcast information comprises transmitting an indication of a flag that enables the UE to generate a uniform resource locator for accessing the service information.

In a third aspect, alone or in combination with one or more of the first and second aspects, transmitting the broadcast information comprises transmitting a temporary mobile group identity that indicates a broadcast or multicast service for accessing the service information.

In a fourth aspect, alone or in combination with one or more of the first through third aspects, transmitting the broadcast information comprises transmitting a uniform resource locator for accessing the service information.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include one or more of an obtaining component 1008, an accessing component 1010, a display component 1012, a connection component 1014, or a selection component 1016, among other examples.

In some aspects, the apparatus 1000 may be configured to perform one or more operations described herein in connection with FIGS. 5-6. Additionally, or alternatively, the apparatus 1000 may be configured to perform one or more processes described herein, such as process 700 of FIG. 7, process 800 of FIG. 8, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The reception component 1002 may receive broadcast information associated with one or more services provided by a network. The obtaining component 1008 may obtain a location for accessing service information that describes the one or more services based at least in part on the broadcast information. The accessing component 1010 may access the service information based at least in part on the location.

The display component 1012 may display the service information via a display associated with the UE. The reception component 1002 may receive an indication of a selected service of the one or more services provided by the network. The display component 1012 may display information associated with the selected service based at least in part on the indication of the selected service. The connection component 1014 may connect to the network prior to displaying the information associated with the selected service.

The obtaining component 1008 may obtain an indication of one or more detected networks based at least in part on a scanning operation. The reception component 1002 may receive, from a network entity, an indication of one or more available networks. The selection component 1016 may select a network based at least in part on the network being included in the indication of the one or more detected networks and the indication of the one or more available networks. The connection component 1014 may connect to the network based at least in part on selecting the network. The accessing component 1010 may access service information associated with one or more services provided by the network.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally. or alternatively, a set of (one or more) components shown in FIG. 10 may perform one or more functions described as being performed by another set of components shown in FIG. 10.

FIG. 11 is a diagram of an example apparatus 1100 for wireless communication. The apparatus 1100 may be a network entity, or a network entity may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 150. The communication manager 150 may include an obtaining component 1108, among other examples.

In some aspects, the apparatus 1100 may be configured to perform one or more operations described herein in connection with FIGS. 5-6. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the network entity described in connection with FIG. 2. Additionally, or alternatively, one or more components shown in FIG. 11 may be implemented within one or more components described in connection with FIG. 2. Additionally. or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network entity described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the network entity described in connection with FIG. 2. In some aspects, the transmission component 1104 may be co-located with the reception component 1102 in a transceiver.

The obtaining component 1108 may obtain a configuration for transmitting broadcast information that is associated with one or more services provided by a network and that enables a UE to obtain a location for accessing service information that describes the one or more services. The transmission component 1104 may transmit a broadcast communication that includes the broadcast information.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving broadcast information associated with one or more services provided by a network: obtaining a location for accessing service information that describes the one or more services based at least in part on the broadcast information; and accessing the service information based at least in part on the location.

Aspect 2: The method of Aspect 1, wherein receiving the broadcast information comprises receiving a key, wherein obtaining the location for accessing the service information comprises generating a uniform resource locator (URL) based at least in part on the key, and wherein accessing the service information comprises accessing the service information via the URL.

Aspect 3: The method of Aspect 2, wherein generating the URL based at least in part on the key comprises generating the URL based at least in part on the key and a tracking area code.

Aspect 4: The method of any of Aspects 1-3, wherein receiving the broadcast information comprises receiving an indication of a flag, wherein obtaining the location for accessing the service information comprises generating a uniform resource locator (URL) based at least in part on the indication of the flag, and wherein accessing the service information comprises accessing the service information via the URL.

Aspect 5: The method of any of Aspects 1-4, wherein receiving the broadcast information comprises receiving a temporary mobile group identity (TMGI), wherein obtaining the location for accessing the service information comprises obtaining a location of a broadcast or multicast service associated with the TMGI, and wherein accessing the service information comprises accessing the service information via the broadcast or multicast service.

Aspect 6: The method of Aspect 5, wherein accessing the service information via the broadcast or multicast service comprises accessing the service information via the broadcast or multicast service without registering to the network or prior to registering to the network.

Aspect 7: The method of any of Aspects 1-6, wherein receiving the broadcast information comprises receiving a uniform resource locator (URL) that is included in a broadcast message, wherein obtaining the location for accessing the service information comprises obtaining the URL from the broadcast message, and wherein accessing the service information comprises accessing the service information via the URL.

Aspect 8: The method of any of Aspects 1-7, further comprising displaying the service information via a display associated with the UE.

Aspect 9: The method of Aspect 8, further comprising: receiving an indication of a selected service of the one or more services provided by the network; and displaying information associated with the selected service based at least in part on the indication of the selected service.

Aspect 10: The method of Aspect 9, wherein receiving the indication of the selected service comprises receiving an indication of a manual selection of the service by a user of the UE.

Aspect 11: The method of Aspect 9, further comprising connecting to the network prior to displaying the information associated with the selected service.

Aspect 12: The method of any of Aspects 1-11, wherein receiving the broadcast information comprises receiving the broadcast information via a different network.

Aspect 13: A method of wireless communication performed by a user equipment (UE), comprising: obtaining an indication of one or more detected networks based at least in part on a scanning operation: receiving, from a network entity, an indication of one or more available networks; and selecting a network based at least in part on the network being included in the indication of the one or more detected networks and the indication of the one or more available networks.

Aspect 14: The method of Aspect 13, further comprising connecting to the network based at least in part on selecting the network.

Aspect 15: The method of Aspect 14, further comprising accessing service information associated with one or more services provided by the network.

Aspect 16: The method of any of Aspects 13-15, wherein receiving the indication of the one or more available networks comprises: generating a fully qualified domain name (FQDN) that includes a current tracking area code of a serving network that is serving the UE; generating an Internet Protocol (IP) address based at least in part on the FQDN and a domain name system; and receiving the indication of the one or more available networks using the IP address.

Aspect 17: A method of wireless communication performed by a network entity, comprising: obtaining a configuration for transmitting broadcast information that is associated with one or more services provided by a network and that enables a user equipment (UE) to obtain a location for accessing service information that describes the one or more services; and transmitting a broadcast communication that includes the broadcast information.

Aspect 18: The method of Aspect 17, wherein transmitting the broadcast information comprises transmitting a key that enables the UE to generate a uniform resource locator for accessing the service information.

Aspect 19: The method of any of Aspects 17-18, wherein transmitting the broadcast information comprises transmitting an indication of a flag that enables the UE to generate a uniform resource locator for accessing the service information.

Aspect 20: The method of any of Aspects 17-19, wherein transmitting the broadcast information comprises transmitting a temporary mobile group identity that indicates a broadcast or multicast service for accessing the service information.

Aspect 21: The method of any of Aspects 17-20, wherein transmitting the broadcast information comprises transmitting a uniform resource locator for accessing the service information.

Aspect 22: An apparatus for wireless communication at a device, comprising a processor: memory coupled with the processor; and instructions stored in the memory and executable by the processor to cause the apparatus to perform the method of one or more of Aspects 1-12.

Aspect 23: A device for wireless communication, comprising a memory and one or more processors coupled to the memory, the one or more processors configured to perform the method of one or more of Aspects 1-12.

Aspect 24: An apparatus for wireless communication, comprising at least one means for performing the method of one or more of Aspects 1-12.

Aspect 25: A non-transitory computer-readable medium storing code for wireless communication, the code comprising instructions executable by a processor to perform the method of one or more of Aspects 1-12.

Aspect 26: A non-transitory computer-readable medium storing a set of instructions for wireless communication, the set of instructions comprising one or more instructions that, when executed by one or more processors of a device, cause the device to perform the method of one or more of Aspects 1-12.

Aspect 27: An apparatus for wireless communication at a device, comprising a processor: memory coupled with the processor; and instructions stored in the memory and executable by the processor to cause the apparatus to perform the method of one or more of Aspects 13-16.

Aspect 28: A device for wireless communication, comprising a memory and one or more processors coupled to the memory, the one or more processors configured to perform the method of one or more of Aspects 13-16.

Aspect 29: An apparatus for wireless communication, comprising at least one means for performing the method of one or more of Aspects 13-16.

Aspect 30: A non-transitory computer-readable medium storing code for wireless communication, the code comprising instructions executable by a processor to perform the method of one or more of Aspects 13-16.

Aspect 31: A non-transitory computer-readable medium storing a set of instructions for wireless communication, the set of instructions comprising one or more instructions that, when executed by one or more processors of a device, cause the device to perform the method of one or more of Aspects 13-16.

Aspect 32: An apparatus for wireless communication at a device, comprising a processor: memory coupled with the processor; and instructions stored in the memory and executable by the processor to cause the apparatus to perform the method of one or more of Aspects 17-21.

Aspect 33: A device for wireless communication, comprising a memory and one or more processors coupled to the memory, the one or more processors configured to perform the method of one or more of Aspects 17-21.

Aspect 34: An apparatus for wireless communication, comprising at least one means for performing the method of one or more of Aspects 17-21.

Aspect 35: A non-transitory computer-readable medium storing code for wireless communication, the code comprising instructions executable by a processor to perform the method of one or more of Aspects 17-21.

Aspect 36: A non-transitory computer-readable medium storing a set of instructions for wireless communication, the set of instructions comprising one or more instructions that, when executed by one or more processors of a device, cause the device to perform the method of one or more of Aspects 17-21.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
receiving broadcast information associated with one or more services provided by a network:
obtaining a location for accessing service information that describes the one or more services based at least in part on the broadcast information; and
accessing the service information based at least in part on the location.

2. The method of claim 1, wherein receiving the broadcast information comprises receiving a key, wherein obtaining the location for accessing the service information comprises generating a uniform resource locator (URL) based at least in part on the key, and wherein accessing the service information comprises accessing the service information via the URL.

3. The method of claim 2, wherein generating the URL based at least in part on the key comprises generating the URL based at least in part on the key and a tracking area code.

4. The method of claim 1, wherein receiving the broadcast information comprises receiving an indication of a flag, wherein obtaining the location for accessing the service information comprises generating a uniform resource locator (URL) based at least in part on the indication of the flag, and wherein accessing the service information comprises accessing the service information via the URL.

5. The method of claim 1, wherein receiving the broadcast information comprises receiving a temporary mobile group identity (TMGI), wherein obtaining the location for accessing the service information comprises obtaining a location of a broadcast or multicast service associated with the TMGI, and wherein accessing the service information comprises accessing the service information via the broadcast or multicast service.

6. The method of claim 5, wherein accessing the service information via the broadcast or multicast service comprises accessing the service information via the broadcast or multicast service without registering to the network or prior to registering to the network.

7. The method of claim 1, wherein receiving the broadcast information comprises receiving a uniform resource locator (URL) that is included in a broadcast message, wherein obtaining the location for accessing the service information comprises obtaining the URL from the broadcast message, and wherein accessing the service information comprises accessing the service information via the URL.

8. The method of claim 1, further comprising displaying the service information via a display associated with the UE.

9. The method of claim 8, further comprising:
receiving an indication of a selected service of the one or more services provided by the network; and
displaying information associated with the selected service based at least in part on the indication of the selected service.

10. The method of claim 9, wherein receiving the indication of the selected service comprises receiving an indication of a manual selection of the service by a user of the UE.

11. The method of claim 9, further comprising connecting to the network prior to displaying the information associated with the selected service.

12. The method of claim 1, wherein receiving the broadcast information comprises receiving the broadcast information via a different network.

13. A method of wireless communication performed by a user equipment (UE), comprising:
obtaining an indication of one or more detected networks based at least in part on a scanning operation;
receiving, from a network entity, an indication of one or more available networks; and
selecting a network based at least in part on the network being included in the indication of the one or more detected networks and the indication of the one or more available networks.

14. The method of claim 13, further comprising connecting to the network based at least in part on selecting the network.

15. The method of claim 14, further comprising accessing service information associated with one or more services provided by the network.

16. The method of claim 13, wherein receiving the indication of the one or more available networks comprises:
generating a fully qualified domain name (FQDN) that includes a current tracking area code of a serving network that is serving the UE:
generating an Internet Protocol (IP) address based at least in part on the FQDN and a domain name system; and
receiving the indication of the one or more available networks using the IP address.

17. A method of wireless communication performed by a network entity, comprising:
obtaining a configuration for transmitting broadcast information that is associated with one or more services provided by a network and that enables a user equipment (UE) to obtain a location for accessing service information that describes the one or more services; and
transmitting a broadcast communication that includes the broadcast information.

18. The method of claim 17, wherein transmitting the broadcast information comprises transmitting a key that enables the UE to generate a uniform resource locator for accessing the service information.

19. The method of claim 17, wherein transmitting the broadcast information comprises transmitting an indication of a flag that enables the UE to generate a uniform resource locator for accessing the service information.

20. The method of claim 17, wherein transmitting the broadcast information comprises transmitting a temporary mobile group identity that indicates a broadcast or multicast service for accessing the service information.

21. The method of claim 17, wherein transmitting the broadcast information comprises transmitting a uniform resource locator for accessing the service information.

22. An apparatus for wireless communication, comprising:
means for receiving broadcast information associated with one or more services provided by a network:
means for obtaining a location for accessing service information that describes the one or more services based at least in part on the broadcast information; and
means for accessing the service information based at least in part on the location.

23. The apparatus of claim 22, wherein receiving the broadcast information comprises receiving a key, wherein obtaining the location for accessing the service information comprises generating a uniform resource locator (URL) based at least in part on the key, and wherein accessing the service information comprises accessing the service information via the URL.

24. The apparatus of claim 23, wherein generating the URL based at least in part on the key comprises generating the URL based at least in part on the key and a tracking area code.

25. The apparatus of claim 22, wherein receiving the broadcast information comprises receiving an indication of a flag, wherein obtaining the location for accessing the service information comprises generating a uniform resource locator (URL) based at least in part on the indication of the flag, and wherein accessing the service information comprises accessing the service information via the URL.

26. The apparatus of claim 22, wherein receiving the broadcast information comprises receiving a temporary mobile group identity (TMGI), wherein obtaining the location for accessing the service information comprises obtaining a location of a broadcast or multicast service associated with the TMGI, and wherein accessing the service information comprises accessing the service information via the broadcast or multicast service.

27. The apparatus of claim 26, wherein the means for accessing the service information via the broadcast or multicast service comprises means for accessing the service information via the broadcast or multicast service without registering to the network or prior to registering to the network.

28. The apparatus of claim 22, wherein receiving the broadcast information comprises receiving a uniform resource locator (URL) that is included in a broadcast message, wherein obtaining the location for accessing the service information comprises obtaining the URL from the broadcast message, and wherein accessing the service information comprises accessing the service information via the URL.

29. The apparatus of claim 22, further comprising means for displaying the service information via a display associated with the apparatus.

30. The apparatus of claim 29, further comprising:
means for receiving an indication of a selected service of the one or more services provided by the network; and
means for displaying information associated with the selected service based at least in part on the indication of the selected service.
